(19) United States
(12) Patent Application Publication
(10) Pub. No.: US 2003/0004821 A1
(43) Pub. Date: Jan. 2, 2003

(54) Method and system for interactively negotiating an item price in a physical store while shopping

(75) Inventors: Rabindranath Dutta, Austin, TX (US); Dwip N. Banerjee, Austin, TX (US)

Correspondence Address: Darcell Walker, 8107 Carvel Lane, Houston, TX, 77036, US

(73) Assignee: INTERNATIONAL BUSINESS MACHINES CORPORATION, ARMONK, NY (US)

(21) Appl. No.: 09/895,089

(22) Filed: Jun. 29, 2001

(51) Int. Cl. G06F 17/60; G06G 7/00

(52) U.S. Cl. 705/26; 705/27; 705/400

(57) ABSTRACT

This invention provides a method and system to support dynamic pricing at a reasonable cost. In this context, dynamic pricing means there may be different prices for individual customers that want to purchase the same product. The price discounts in stores are typically for all customers or for a group or member customers. Stores usually do not have a practice of granting individualized pricing for particular items. However, for some products that may have slow sales, the store may be willing to consider a price by an individual customer that desires that product. This invention enables a store to tailor price discounts to an individual person.

### FIELD OF THE INVENTION

This invention relates to the negotiation and purchase of consumer products and services and in particular to the interactive negotiation of a purchase price for an item by a customer while that customer is shopping in the vicinity of a physical location offering the item that is the subject of the negotiation and purchase.

### BACKGROUND OF THE INVENTION

Consumption is the lifeblood of the major economies of the world. Consumption requires the acquisition of the products and services. These acquisitions occur between consumers and merchants (entities that own the desired goods and services) through transactions in which there is an exchange of a medium (usually currency) from the buyer to the merchant for commodities valuable to the merchant. The transaction is known as a sale. In a typical sale, the merchant displays their items for sale. This display contains the purchase price for which a merchant will sell (transfer) the item to the prospective buyer. In the large majority of transactions the purchase price is not subject to negotiation. The price listed for the item is the only price for which the merchant will sell the item. However, in some transactions involving the purchase of large ticket items such as an automobile or the purchase of a house, the listed purchase price is often the starting price at which the parties begin negotiations for the final purchase price. Typically merchants do not negotiate purchase prices because of the expense involved in offering bargain based sales, however with the advent of ubiquitous computing it is now possible to support such paradigms.

In the negotiation of an automobile the merchant/dealer usually lists on the automobile the price at which they desire to sell the automobile. However, the autodealer also has a minimum price at which they will sell the car. This medium price is not listed anywhere on the automobile. In addition, the potential customer does not initially know the minimum price at which the dealer will sell the automobile. However, because consumers over the years have become aware that the listed price is not the absolute price at which the dealer will sell the automobile, consumers have developed a practice during the purchase of an automobile of negotiating the final purchase price for the automobile. Many consumers view the listed price as the price at which to begin negotiations for the purchase of the automobile. Therefore, if a potential customer is interested in a particular automobile, one of the first steps by the customer is to determine the lowest price at which the dealer will sell the automobile or the highest price the customer is willing to pay for the automobile.

This method of price negotiation also occurs in the purchase of other products such as houses and in some arenas such as flea markets and garage sales. However, price negotiations for the purchase products do not usually occur in the purchase of standard items such as food, clothes or most consumer products. In these arenas, the merchant has total control over the final purchase price for an item. If a purchaser does not like to price of a product, the purchaser's only option is to select another product in the preferred price range or to seek the product at another store with the intention of finding the product at a more preferable price. The option of negotiating a different price with the merchant is generally not a consideration of the purchaser.

In recent years, there has been some movement in the direction of consumers negotiating the final purchase price for a desired good or service. U.S. Pat. No. 5,797,127 describes a method, apparatus and program for negotiating the price of airline tickets. This patent describes a method, apparatus, and program for pricing, selling, and exercising options to purchase airline tickets. The invention advantageously enables ticket buyers, for a nominal premium, to lock in a guaranteed price at which they can purchase an airline ticket, without committing themselves to purchasing the ticket, without tying up the full purchase price of the ticket, and without putting the full purchase price of the ticket at risk in case the customer's travel plans change. The invention also advantageously provides the seller with an opportunity to profit by selling options to buy airline tickets. In particular, one aspect of the present invention is directed to a method of pricing options to purchase airline tickets. This method includes inputting information specifying where a customer wishes to depart from and where he wishes to fly to, and at least one time when the customer desires to travel. A price for an option that gives the customer a right to purchase a ticket to fly from the origin to the destination during a desired time is calculated and output. The purchase price of the ticket is one of the terms of the option.

U.S. Pat. Nos. 5,794,207 and 5,797,127 suggest that there have been some recent efforts to introduce new ways and methods of purchasing products that benefit both the buyer and the seller. Today, there are dozens of different buyer-seller protocols in use today. However, almost all of those systems are seller-driven in the sense that they focus on the methods and processes available to the seller, allowing him to price, package or configure goods and services more effectively. Stores, catalogs, classified advertisements, telemarketing, auction houses, even on-line computerized reservation systems such as SABRE, are all seller-driven. Traditionally, it is the seller's job to attract buyers and then to complete the sale. Thus, in a seller-driven system, the advertising cost of the transaction and the attendant risks that such advertising will be unsuccessful falls upon the seller.

Most goods and services sold at retail are done so using a general seller-driven protocol whereby the seller sets a price and the buyer decides whether or not to accept that price. Prices for some services, such as airline tickets, might change frequently, but the buyer must still wait for the seller to offer a price he finds acceptable. Obviously, some forms of commerce offer far more give and take with offers and counteroffers being exchanged, however the vast majority of retail purchases utilize seller-driven, fixed-price, non-negotiable pricing protocols.

Auctions are probably the most frequently used system whereby the seller does not fix prices. Here too, the system is seller-driven. The buyer does not find the seller, rather the seller attracts numerous buyers who, as a group, determine the final selling price—which the seller may subsequently reject unless the item auctioned is being sold without a reserve.

Even on-line reservation systems are seller-driven. Airline reservation systems such as SABRE are in the business of constantly posting airfares. Travel agents and consumers are on the bid side of the process. However, since they cannot communicate their bids to the airlines, they must wait until an “asked” fare is quoted which meets their needs.

Other commerce systems are exchange-driven. These systems, such as NASDAQ or the New York Stock Exchange (NYSE) match buyers and sellers by offering an efficient, fair and orderly marketplace. They favor neither buyers nor sellers, but simply effectuate communications that allow for the matching process to take place. An example of an automated exchange-driven commerce system for trading futures is disclosed in U.S. Pat. No. 4,903,201.

A buyer-driven system is one in which buyers find sellers, such as a “wanted to buy” classified ad. A help wanted ad is a buyer-driven inquiry since the employer is looking to locate and buy the services of a qualified employee. The inquiry is advertised to a large number of potential “sellers,” a number of which may respond by submitting their resumes to the prospective employer.

Buyer-driven systems yield certain benefits and efficiencies that other commerce systems do not. Buyers using such a system can exercise more control over the terms and conditions of their purchases. Additionally, when a large number of potential sellers exist, but those sellers do not have the resources to advertise globally, it makes sense for buyers, if they can, to take the initiative in communicating its needs to the sellers.

Currently, there exist certain unilateral buyer-driven systems of commerce. A good example of such a system is the typical reward system wherein a “buyer” broadcasts/publishes an offer for a reward to anyone who completes a particular task. That type of system is unilateral because the offer can only be accepted by performance of the designated task. Thus, unilateral systems can be utilized only for limited types of transactions, which allow for acceptance by performance.

Bilateral buyer-driven systems seek to consummate contracts between buyers and sellers based on mutual promises to perform. Bilateral buyer-driven systems, however, currently represent an extremely small portion of overall commerce due to a variety of factors. First, and perhaps foremost, buyers generally either cannot or do not want to invest the time, money or other resources required to locate an indefinite number of potential sellers and communicate the buyer's purchasing needs to each of the potential sellers. This is especially true of the individual consumer who often cannot afford to pay substantial transaction costs.

For example, an individual seeking car repair services generally would not want to contact every single repair shop and communicate details of his repair needs to each.

The benefits to the consumer from doing so (e.g., achieving a lower price) would be vastly outweighed by the amount of time and money expended in the effort. Also, buyer-driven systems are not prevalent because buyers do not want to be inundated with numerous offers from potential sellers, many who may be marginal or unqualified (e.g. a thousand real estate brokers or car dealers all calling one buyer).

Buyer-driven systems impose inherent costs on sellers as well. If each buyer has a different set of purchasing specifications and communicates his needs using non-uniform language, sellers must pay a substantial cost even to review and understand each individual request. Moreover, sellers are often not amenable to customizing their products for individual buyers.

As a rule, the greater the number and complexity of the buyer's purchase conditions, the more difficult it is to have a buyer-driven market, since advertising costs generally rise with the number of conditions that must be communicated, and the potential number of sellers who can understand and fulfill increasingly complex conditions usually declines. Buyer-driven markets function best when there is a well-defined purchase need, when a “brand” provides quality assurance to the buyer such as the name of a major airline carrier or when the item is a commodity such as oil or coal. An example of a regularly used bilateral buyer-driven process is the system utilized by large organizations such as companies or governments which want to purchase significant amounts of goods or services at the lowest possible price. To begin, they formulate a detailed written specification setting forth the quantities and requirements of what they are looking to buy. This document is typically called a “Request for Proposal” (RFP). Once finalized, RFPs are then distributed to a list of known potential suppliers. If the value of the RFP is high enough, as it is might be with a large government contract, the buyer may bear the added expense of trying to attract the widest number of sellers by paying to publish the RFP in newspapers and trade magazines. As commerce seeks to utilize the inherent advantages of the Internet, many types of commerce systems, such as malls, catalogs and auction house, are being implemented on the Internet. These approaches generally seek to create better seller or exchange-driven systems whereby the sale of goods and services is made more efficient.

While there have been some attempts to use the Internet to effectuate bilateral buyer-driven transactions, those attempts have been largely unsuccessful. Currently, there are “bulletin board” type sites on the Internet where buyers can post “wanted” advertising at little or no cost. Thus, any consumer could post his own RFP looking for companies willing to sell him the exact airline tickets they are looking to buy or a particular car with specified options included. Because Internet postings are global, the buyer theoretically has the ability to communicate his RFP to a large number of potential sellers. In practice, however, this process is ineffective as a buyer-driven system of commerce because potential sellers generally do not frequent the various “bulletin board” sites or respond to the individual RFPs.

Although some new product purchasing systems have been developed recently that use the Internet to facilitate the negotiation and purchase of a product, these systems are not applicable to the large majority of purchase. Most purchases occur in person. As a customer examines a product and the product price, there is no systematic or automated means through which the customer can attempt to negotiate the purchase price for that product.

### SUMMARY OF THE INVENTION

It is an objective of this invention to help create an environment that can facilitate individualized price negotiations for a particular product.

It is a second objective of this invention to provide for interactive and dynamic price negotiations of a price at the point of the sell of the product.

It is a third objective of this invention to provide a method to perform price negotiations for an item over a wireless communication means.

It is a fourth objective of this invention to provide for the wireless communications to occur over a radio frequency based protocol.

It is a fifth objective of this invention is to use service discovery mechanisms to detect services that are available on devices for a particular application environment such as a store.

This invention provides a method and system to support dynamic pricing at a reasonable cost. In this context, dynamic pricing means there may be different prices for individual customers that want to purchase the same product. The price discounts in stores are typically for all customers or for a group or member customers. Stores usually do not have a practice of granting individualized pricing for particular items. However, for some products that may have slow sales, the store may be willing to consider a price by an individual customer that desires that product. For example, stores can give greater discounts to valued customers. This invention enables a store to tailor price discounts to an individual person.

The system of the present invention comprises a wireless handset or personal digital assistant (PDA). The store can provide these PDA headsets. The customer uses this device to scan the product and retrieve information concerning the product. This customer will also use the PDA to communicate their proposed price for a product to the entity in the store that will respond to the price proposal. A product price server receives the price proposal from the customer. Within the product price server is a product price database and a decision making engine. This decision-making engine can also be human.

The main components to support an interactive pricing mechanism for products are the user's wireless handset/PDA communicating via instant messaging with the store's product price server (and accompanying database) and the cashier server (and its transactional database). Since the entire solution is played out physically inside a store, a location based wireless protocol that works in a constrained space is necessary. The Bluetooth protocol is an appropriate radio frequency based protocol for this purpose. Since the Bluetooth protocol has a radius of about 30 feet, server computer inputs are scattered through the store such that they communicate with the appropriate PDAs. This arrangement is different from the obvious prior art scheme of connecting for instant messaging etc. via the public Internet. Where computers have to be physically wired in, this situation raises a different and obvious priority scheme of connecting for instant messaging via the public Internet. The advantage of this invention is faster and more robust communications with immediate arbitration.

In operation, a customer would enter the store and retrieve one of the handheld/PDA devices. The customer would then select a product for which they desire to submit a price proposal. The customer would scan the product with the PDA to retrieve information concerning that product. The customer could also submit a price proposal without retrieving the product information. Upon submission of the proposed price, the product price server receives and processes the price submission. The decision-making entity receives the information in the price proposal and ultimately reaches a decision on the price proposal submitted by the customer. The decision-making entity could be housed in the product server and could contain artificial intelligence that assists in this decision. Information about the product is contained in the product price server database. The decision-making entity (human or machine) could review the information about prior transactions for that product. The present decision could be based on this information. The decision-making entity can choose to reject the price proposal, accept the price proposal or submit a counter offer to the customer. The customer can then accept or reject the counter offer or submit a second offer in response to the received counter-offer. This iterative process will continue until the participants agree to a price for the product or until the participants conclude that there will be no discounted sale of this product.

### DESCRIPTION OF THE DRAWINGS

FIG. 1 is a layout of a store containing products and equipment that will enable a customer to practice the present invention in the store.

FIG. 2 shows the communication structure between entities that participate in this product price negotiation scheme

FIG. 3 is a view of the structural diagram for the negotiation used to decide a prices for an item in a store.

FIG. 4 shows a flow diagram of the sequence of steps in the process of negotiating a purchase price for a product.

FIG. 5 is a flow diagram of the steps involved in the implementation of the present invention using the Bluetooth connection set-up and protocol.

FIG. 6 is a flow diagram of the steps for connecting to a services discovery database.

FIG. 7 is a flow diagram of the steps involved in establishing a Bluetooth connection to a service.

### DETAILED DESCRIPTION OF THE INVENTION

The preferred embodiment of the present invention describes a system for dynamic, interactive negotiated pricing of items in a physical store between a producer and a consumer using the Bluetooth protocol.

The Bluetooth wireless technology allows users to make effortless, wireless and instant connections between various communication devices, such as mobile phones and desktop and notebook computers. Since it uses radio transmission, transfer of both voice and data is in real-time. The sophisticated mode of transmission adopted in the Bluetooth specification ensures protection from interference and security of data.

The Bluetooth radio is built into a small microchip and operates in a globally available frequency band ensuring communication compatibility worldwide. The Bluetooth specification has two power levels defined; a lower power level that covers the shorter personal area within a room, and a higher power level that can cover a medium range, such as within a home. Software controls and identity coding built into each microchip ensure that only those units preset by their owners can communicate. The Bluetooth wireless technology supports both point-to-point and point-to-multipoint connections. With the current specification, up to seven ‘slave’ devices can be set to communicate with a ‘master’ radio in one device. Several of these ‘piconets’ can be established and linked together in ad hoc ‘scattemets’ to allow communication among continually flexible configurations. All devices in the same piconet have priority synchronization, but other devices can be set to enter at any time. The topology can best be described as a flexible, multiple piconet structure.

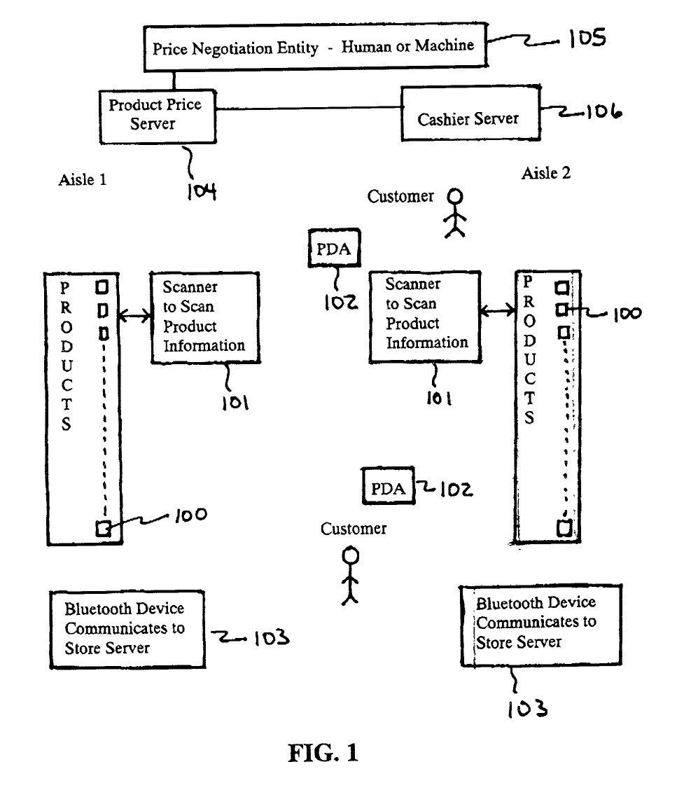

Referring to FIG. 1, there is a physical layout of the components for implementation of the present invention in a store environment. The products 100 are stored on aisle. Product scanning devices 101 are located on each aisle. These scan the product and submit data requests to the product price database for information on that product. The PDA 102 can also have the product price scanning capability. The scanner devices could also be attachment devices to the PDA. The scanner could also have ability to assist the customer during this process. Because the Bluetooth protocol used only has a range of approximately 30 feet, Bluetooth devices 103 are located at certain points in the store to enable communication between the customer and the store's product price server 104. These Bluetooth devices serve as communication links and data transmitters of information between devices in the store. The price negotiation entity 105 (also referred to as the decision-making entity) can be human or machine. If this entity is a machine, it can located in the product price server and can have artificial intelligence that is used to make pricing decisions. The customer communicates any product price decision to the cashier server 106 for payment.

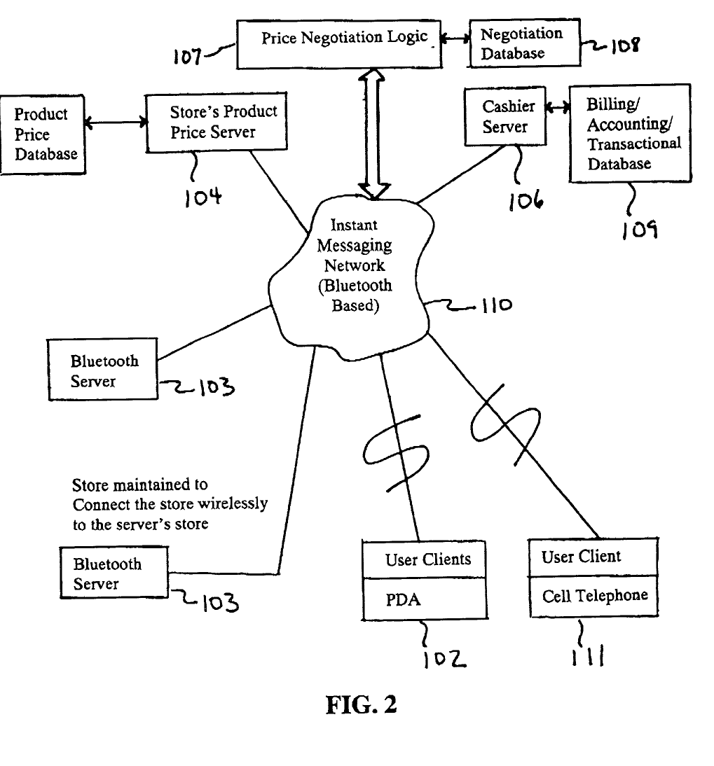

FIG. 2 shows the communication structure between entities that participate in this product price negotiation scheme. As shown in this diagram, the price negotiation logic 107 communicates directly with a negotiation database 108. The product price database 108 communicates with and through the store's product price server 104. The billing/accounting/transactional database 109 communicates with and through the cashier server 106. As shown all other communications between entities occur via the network 110 based in Bluetooth protocol. This network is dynamically formed inside the store and enables users to send messages to the store server, get price or accounting information, pay bills or contact the decision-making entity to conduct the price negotiations. The Bluetooth server devices contain logic that enables communication from the customers (PDA, cellular telephone) to the product price server and the other store maintained servers such as the cashier server, product drives and negotiation programs. This Bluetooth logic enables the devices to communicate in a wireless fashion. These Bluetooth servers 103 are located at various locations in a store (typically at the end of each aisle) and enables this wireless communication between devices. In addition to the PDA's 102, a user can communicate with the Bluetooth server 103 and therefore the wireless store network via a cellular telephone 111.

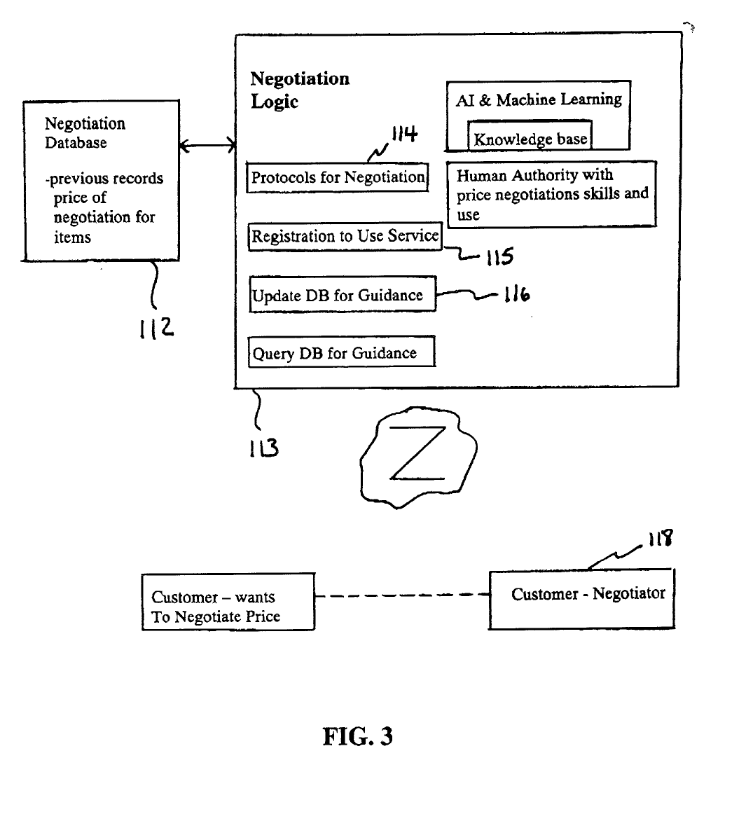

FIG. 3 illustrates the negotiation structure of the present invention. As shown, there is a negotiation database 112 contains the selling history of a product. This information can include the various prices at which the store has sold a particular product and rationales behind the sale of product at a particular price such as seasonal supply patterns or periodic purchasing patterns of consumers. The negotiation structure also contains negotiation logic 113 that contains the decision-making mechanisms involved in the price negotiations. This mechanism could be artificial intelligence and machine learning capabilities or the decision-making mechanism could be a human with the authority to negotiate prices. The decision-making mechanism could also be a combination of human and machine. Other features of the negotiation logic includes the protocols used for product price negotiations 114, a registration service 115, programs that update the negotiations database 116, and protocols that enable the store negotiator to query the database to get information about the price history of a product. Also shown is a wireless connection 117 that will enable a customer 118 to communicate with the negotiation logic or send a signal that the customer wants to negotiate a price for a particular product.

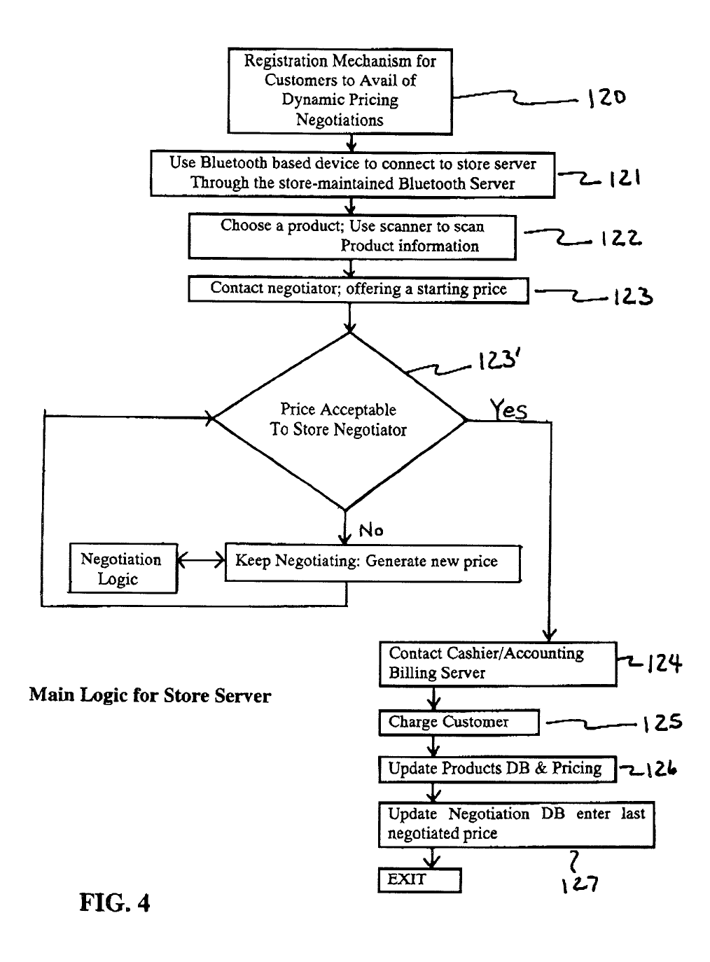

FIG. 4 shows a flow diagram of the sequence of steps in the process of negotiating a purchase price for a product. This price negotiation procedure provides for a mechanism for each potential customer negotiator to register for the dynamic pricing negotiations service of the present invention 120. Each registered customer would receive an identification number, which would enable the service to know whether a person attempting to utilize the service is registered for use of the service. Once the register has gained access to the service, the customer uses the Bluetooth server 103 to connect to the store server 104 in step 121. The customer uses the PDA to access the store server via the Bluetooth server. Once the customer has gained access to the product negotiation service, the customer selects a product for price negotiation and purchase 122. In process of selecting a product, the customer uses a scanner to identify the product and receive product information. This information could include the price of the product and the means through which the store internally identifies the product. An identification means could be a product identification number. After the customer has received product information, the customer uses the PDA to contact the store negotiator and submit a proposed purchase price for the product 123. If the submitted price is acceptable to the store negotiator as determined in step 123′, the cashier server is contacted in step 124 and the price of that product for that customer is entered into the cashier server. When that customers arrives at the cashier to pay for their items, the agreed to price will show when a cashier scans that item and will charge the customer accordingly 125. Following the purchase, the next step is to update the products database and pricing information to include the recently completed transaction 126. This database contains inventory information such as the product item cleared at price X. The process also updates the negotiation database to include the last negotiated price of the product 127. This negotiation database contains the entire negotiation history of the product. The negotiation history contains information such as bids and counter-bids offered, the final sale price and the particular customer that made the purchase. This step 127 completes the product purchase process.

Referring back to step 123, if the store negotiator rejects the price submission of the customer, the customer receives the response that the store rejects the offer. The store negotiator can respond with a simple no rejection, or the store negotiator can submit to the customer a counter offer containing a new price which is higher than the original offer by the customer. At this point, the process is back at step 123′ and the customer has to submit a price for the product. If the customer accepts the price of the store negotiator, that price becomes the acceptable price in step 123. The process has an acceptable price and moves to step 124.

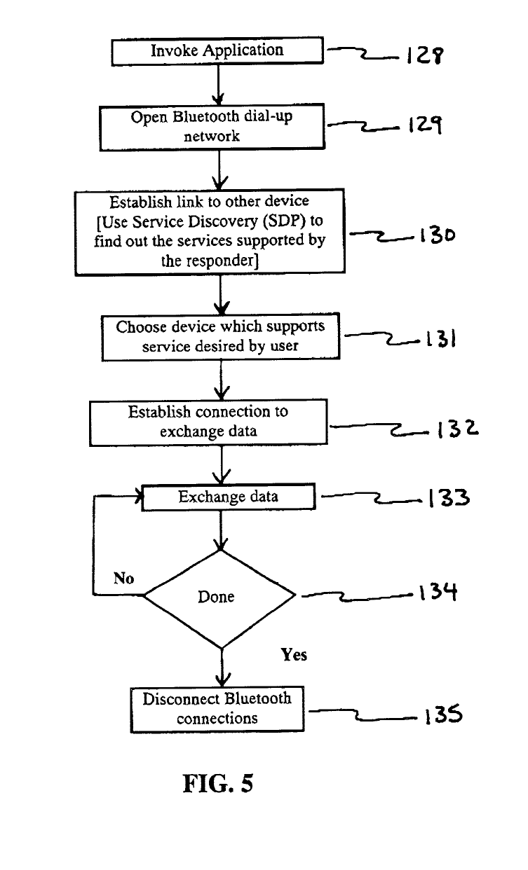

FIG. 5 shows a flow diagram of the steps in the implementation of the present invention using the Bluetooth protocol. In the initial step 128, a customer that desires to negotiate a price for product would gain access to the price negotiation method and system by invoking the negotiation program. This step would be the initialization phase of the system. Step 129 would be to open the Bluetooth dial-up network. The next step in this process is to establish a connection between the PDA used by the customer and service devices in the store. The implementation of this step begins invoking the Bluetooth dial-up network 129. This step is similar to the step users of a global communication network implement in a dial-up procedure to initially establish communication with other devices in the network. After gaining access to the network through the dial-up procedure, the customer establishes a link to one of the Bluetooth server devices on the network 130. To establish this link requires the use of a Service Discovery Protocol (SDP). This SDP surveys the Bluetooth devices on the network and determines which services the responder supports. In this present case, the responder is one of the Bluetooth servers. As previously described, the present system that implements the Bluetooth protocol using Bluetooth servers to serve as links between the customer and the main store server. In some instances, one Bluetooth server in the store may perform different functions than another Bluetooth server. These various functions all relate to the negotiation and purchase of a product. For example, one Bluetooth server may be used strictly to negotiate product prices. This server would be used in the actual communication with the store negotiator. A second Bluetooth server may be used to perform printing functions. These printing functions could involve printing tags or coupons indicating the negotiated purchase price for the customer for that product. Another server may connect with the product database that contains product price information. Once the SDP determines the services available at each Bluetooth server, the customer will choose the appropriate server device that provides the service desired by the customer 131. At this point, the customer will establish a connection with that particular server device 132 for the purpose of exchanging information with some destination device. If the customer chooses the product price negotiation server, the customer would establish a connection to the particular server, which would be connected to store negotiator. This connection would enable the customer to communicate and exchange information with the store negotiator through the main store server as part of the price negotiation transaction 133. At the completion of the transaction, there is determination whether the customer has completed all desired transactions with that Bluetooth server device 134. If the customer has completed all transactions, the Bluetooth connection is disconnected in step 135. If there are other transactions, the process returns to step 133 and repeat the process for the next type of transaction.

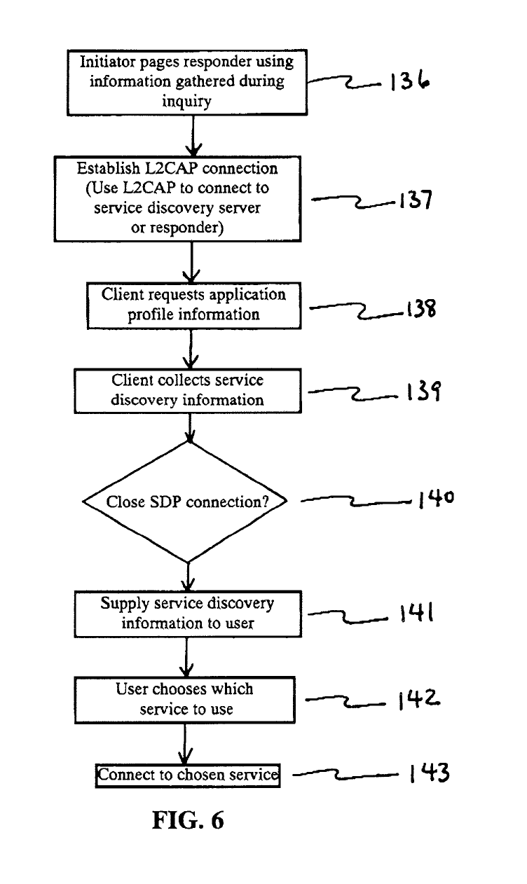

FIG. 6 further illustrates the steps involved in using the SDP to determine the services supported by each Bluetooth server in the network. In this process, the first step is to page the different devices and inquire as to the service that the device offers 136. This inquiry could be in the form of sending out a signal to each server requesting that the server submit information describing the server's functions. This server response could be a signal that has a specific meaning. There could be particular signal indicating that one server performs printing services and a different signal indicating negotiating services or billing services. The next step 137 is to establish a L2CAP connection to connect to the service discovery server. In this process, once there is a physical connection between the two devices, a logical LINK CONTROL AND ADAPTATION is established. An L2CAP connection is used whenever data has been transferred across Bluetooth devices. L2CAP connection allows many protocols and services to use one baseband link. This link can be used for service discovery. The cell telephone main set up or connection is to the Bluetooth service discovery server on the Bluetooth devices in the store. After connecting to the service discovery server, in the next step 138, the customer would submit an inquiry as to which servers could perform the specific need of the customer. This inquiry would contain information about the specific need of the customer. This customer need could be a description referred to as an application profile. The service discovery server collects this profile information and compiles a list of servers that can perform the need of the customer 139. At this point, there is a decision whether to close the Service Discovery Protocol connection (SDP) 140. If the decision is to close the SDP conncetion, the customer receives the list of servers 141 compiled in step 139. After receiving the information, the customer can choose the desired service 142. The final step 143 is to connect to the chosen service via the appropriate Bluetooth server device.

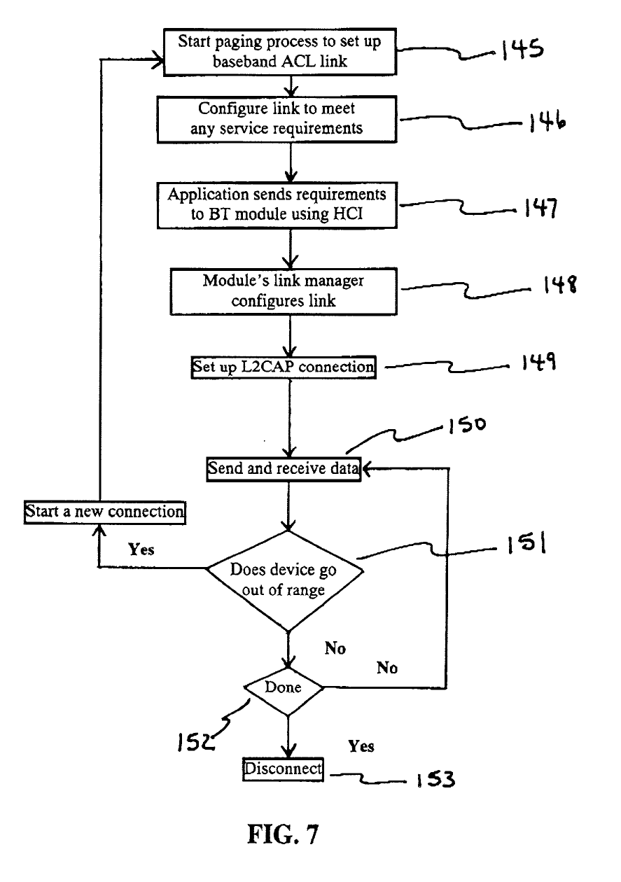

FIG. 7 shows a flow diagram of the steps involved in establishing a data exchange connection described in step 132 of FIG. 5. After a customer has chosen a desired service supported by a particular Bluetooth server as described in step 131, the service connection process begins by initializing the process to set up a baseband ACL (asynchronous connection list) link between the Bluetooth server and the PDA used by the customer 145. ACL links are used for data communication between Bluetooth devices when different variety of packet types are used to send different amounts of data. When the link is set up for a protocol that may have particular quality of service requirements, the application running on the PDA or cellular telephone may wish to configure the link for its requirements. This function is done by the application sending its requirements to the Bluetooth module using the host controller interface. An RFCOMM connection is set up after an L2CAP link is established. (RFCOMM is an RS232 immulation layer that can multiplex several protocols and services across a connection. The dial-up connection is set up using and RFCOMM connection.

Once this link set up process has been initialized, it is necessary to configure or determine the link requirements for the particular service that the customer will use 146. The requirements for a printing service may be different than the link requirements to negotiate a product price. For example, a service may requirement a link with a speed of 9600 baud, where another service may requirement a different transmission rate. Following the configuration of the link requirements, these requirements are sent to the Bluetooth module using a Host Controller Interface (HCI) 147. This Bluetooth module's link manager will configure the link between the PDA and the Bluetooth server 148. After the link is configured, an L2CAP connection is established that connects the PDA and Bluetooth server 149. At this point, the devices can send and receive data 150. During the exchange of data, the customer has to stay within a certain distance of the Bluetooth server in order to implement the Bluetooth protocol. As a result, there is period determination of whether the customer is within the range of the server 151. To accomplish this task, the server or PDA could have a feature that monitors the distance and sends the customer a warning when that customer comes close to a maximum distance from the server. The customer could then reduce the distance. If the customer does go out of range of the server, the connection would end and at that point it would be necessary to re-establish the connection in step 149. This process also has a step that periodically monitors the connection to determine if the connection is still in use 152. If the connection is not in use, the use of the connection is done and the connection disconnects 153. If the connection is not done, the process returns to the data transmission step of 149.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A product purchasing method that enables a customer to interactively negotiate the purchase price of an item in a business location while the customer is in that location, the negotiations occurring over a wireless connection and comprising the steps of:
connecting to a merchant server in that physical location that contains information about the products for sell at that location;
choosing a product for which the customer desires to negotiate a purchase price;
negotiating a purchase price for the chosen product through dynamic interaction with the merchant offering the chosen product for sale; and
establishing a final purchase price for the chosen product.

2. The method as described in claim 1 wherein said negotiating step further comprises offering a purchase price for the chosen product to the merchant offering the product for sale and receiving a response to the purchase price offer from the merchant, said offering and receiving steps repeating until a final purchase price is established.

3. The method as described in claim 1 wherein said server connecting step is implemented using a Bluetooth communication protocol.

4. The method as described in claim 1 further comprising before said connecting step the step of verifying a customer's privilege to connect to the merchant server.

5. The method as described in claim 1 further comprising the step of registering to use the merchant server in a product purchase price negotiation process.

6. The method as described in claim 1 further comprising after said choosing product step, the step of contacting the product database and retrieving information about the purchasing price history of the chosen product.

7. The method as described in claim 6 further comprising after said price establishment step, the steps of:
sending the established final purchasing price to a cashier server;
transacting the payment by the customer for the product; and
updating the product database to include the final purchase price for the product for this transaction.

8. The method as described in claim 1 wherein said negotiations occur by communicating over an instant messaging network that supports dynamic product price negotiations.

10. The method as described in claim further comprising the steps of generating a response to the offer by the customer and submitting that response to the customer.

11. The method as described in claim 10 wherein said response generating step further comprises accessing the pricing history of the chosen product.

12. The method as described in claim 1 further comprising before said choosing step, the step of determining the services available for price negotiations.

13. A computer program product in a computer readable medium to enable a customer to interactively negotiate the purchase price of an item in a business location while the customer is in that location, the negotiations occurring over a wireless connection and comprising:
instructions for connecting to a merchant server in that physical location that contains information about the products for sell at that location;
instructions for choosing a product for which the customer desires to negotiate a purchase price;
instructions for negotiating a purchase price for the chosen product through dynamic interaction with the merchant offering the chosen product for sale; and
instructions for establishing a final purchase price for the chosen product.

14. The computer program product as described in claim 13 wherein said server connecting instructions are implemented using a Bluetooth communication protocol.

15. The computer program product as described in claim 14 further comprising before said connecting instructions, instructions for verifying a customer's privilege to connect to the merchant server.

16. The computer program product as described in claim 14 further comprising instructions for registering to use the merchant server in a product purchase price negotiation process.

17. The computer program product as described in claim 13 further comprising after said product choosing instructions, instructions for contacting the product database and retrieving information about the purchasing price history of the chosen product.

18. The computer program product as described in claim 17 further comprising after said price establishment instructions:
instructions for sending the established final purchasing price to a cashier server;
instructions for transacting the payment by the customer for the product; and
instructions for updating the product database to include the final purchase price for the product for this transaction.

19. A product purchasing system for a customer to interactively negotiate the purchase price of an item from a merchant in a business site while the customer is in that location comprising:
a product purchasing manager located at the business site, said purchasing manager being able to interface with a customer for the purpose of supplying information about a product to a customer;
a wireless interface between said product purchasing manager and a customer, said wireless interface being used by the customer to communicate with said product purchasing manager;
a communication protocol that enables communication between said product purchasing manager and the customer; and
a decision-making entity that negotiates a purchase price for product with the customer.

20. The product purchasing system as described in claim 19 further comprising a bluetooth server that connects said wireless interface with said product purchasing manager, said bluetooth server containing a bluetooth protocol to facilitate communication between said wireless interface and said product purchasing manager.

21. The product purchasing system as described in claim 19 wherein said product purchasing manager comprises:
a product price database;
a cashier server; and
a negotiation database.

22. The product purchasing system as described in claim 19 wherein said product purchasing manager is a server.

23. The product purchasing system as described in claim 19 wherein said wireless interface is a personal digital assistant (PDA) device.

24. The product purchasing system as described in claim 19 wherein said wireless interface is a cellular telephone device.

25. The product purchasing system as described in 19 wherein said decision-making entity comprises price negotiation logic.

26. The product purchasing system as described in claim 19 wherein said wireless interface is an instant messaging network.
